(19) United States
(12) Patent Application Publication
(10) Pub. No.: US 2018/0304671 A1
(43) Pub. Date: Oct. 25, 2018

(54) PEN ASSEMBLY PRESS AND LEVER THEREOF

(71) Applicant: Yu-Chun LIU, Taichung (TW)

(72) Inventor: Yu-Chun LIU, Taichung (TW)

(21) Appl. No.: 15/491,299

(22) Filed: Apr. 19, 2017

(51) Int. Cl. B43K 15/00

(52) U.S. Cl. CPC B43K 15/00

(57) ABSTRACT

A pen assembly press and its lever are disclosed. The lever is installed on either of the pressing mechanisms of the pen assembly press. The lever has a stopping component and particularly a resilient preloading component which consists of a resilient support component between the limiting component and the stopping component, allowing resilient preloading of the stopping component to a certain distance. Therefore, the pen assembly press can achieve greater quickness and accuracy in positioning, smoothness in adjusting operation, and convenience and improvement in using.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

### 1. Field of the Invention

The present invention relates generally to a pen assembly press, and more particularly to an innovative structure pen assembly press having a lever with resilient preloading function.

### 2. Description of Related Art Including Information Disclosed Under 37 CFR 1.97 and 37 CFR 1.98

The pen assembly press referred to in the prior art is a personal auxiliary pen-making device, and the function of the pen assembly press is mainly to assist the user in pressing the pen body tube and the pen nib tube together.

In the design of the structure of a pen assembly press, there is usually a lever-type pressing mechanism and a screw-adjusting-type pressing mechanism at both ends of the base. In terms of operation, the lever-type pressing mechanism is moved to the release state, and then the screw-adjusting-type pressing mechanism is manually adjusted crosswise until the aforementioned pen body tube is pressed against the pen nib tube till they are basically positioned. Specifically, the lever-type pressing mechanism is used to press both tubes together, and the screw-adjusting-type pressing mechanism serves the purpose of screw pressing, basically positioning the two pen parts that are not pressed and joined together. The user holds the pen to keep it placed in the right horizontal position, and then uses the other hand to operate the lever-type pressing mechanism to press the pen parts together.

However, some issues are found in using the above-mentioned pen assembly press. Here is an example. When manually adjust the threaded rod of the screw-adjusting-type pressing mechanism, the crosswise movement is rather slow. Therefore, when both parts of the pen are to be clamped between the lever-type pressing and the screw-adjusting-type pressing mechanism, the user must pay attention to the horizontal accuracy of the pen parts after clamped, while at the same time, have to adjust the position of the threaded rod. This often causes difficulty in precisely positioning the pen parts, leading to inconvenience in using the machine. Therefore, it is worthy of the industry to further address the technical issues and achieve breakthroughs.

Thus, to overcome the aforementioned problems of the prior art, it would be an advancement in the art to provide an improved structure that can significantly improve the efficacy.

Therefore, the inventor has provided the present invention of practicability after deliberate design and evaluation based on years of experience in the production, development and design of related products.

### BRIEF SUMMARY OF THE INVENTION

The “pen assembly press and lever” disclosed in the present invention, due to the innovative and unique component structure and technical features, for example resilient preloading functions guaranteed by the resilient preloading component (consisting of a resilient top support between the limiting component and the stopping component of the lever) installed in the lever mechanism of the pen assembly press, compared with the prior art, can achieve greater quickness and accuracy in positioning, smoothness in adjusting operation, and convenience and improvement in using with the aforesaid resilient preloading component.

In addition, another technical feature, namely the threaded-rod-type switching component at the place where the fixed seat of the second pressing mechanism of screw-adjusting type and the threaded rod join, allows the switch between fine tuning and quick pull and push with the help of the pressing mechanism of screw-adjusting type, and therefore significantly improve the convenience in the operation of pen pressing.

### BRIEF DESCRIPTION OF THE SEVERAL VIEWS OF THE DRAWINGS

FIG. 1 is the combined stereogram of a preferred embodiment of the pen assembly press of the present invention.

FIG. 2 is the local stereogram of a preferred embodiment of the pen assembly press of the present invention.

FIG. 3 is the side view of a preferred embodiment of the pen assembly press of the present invention.

FIG. 4 is the section of the second lever of the present invention.

FIG. 5 demonstrates a state of operation of the pen assembly press of the present invention.

FIG. 6 demonstrates another state of operation of the pen assembly press of the present invention.

FIG. 7 is the section of the second lever of another preferred embodiment of the present invention.

FIG. 8 demonstrates the resilient preloading action of the embodiment indicated in FIG. 7.

FIG. 9 is the section of the second lever with a threaded-rod-type switching component of the present invention.

FIG. 10 is the section of the embodiment of the present invention from the opposite side.

### DETAILED DESCRIPTION OF THE INVENTION

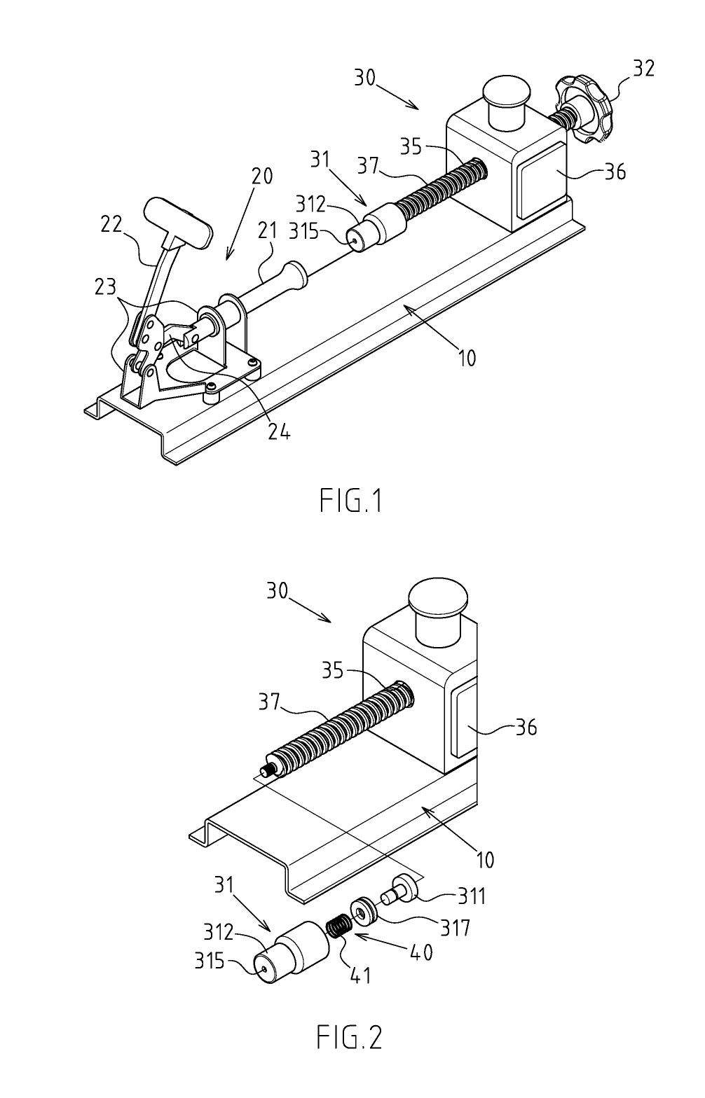

FIGS. 1 to 4 show the preferred embodiments of the present invention for the pen assembly press and its lever.

However, such embodiments are for illustrative purposes only and are the patent application is not subject to the structure.

Said pen assembly press comprises the following components: abase 10 which is in the form of a long seat extending in an axial direction and comprises a component mounting surface 11; the first pressing mechanism 20 mounted on the component mounting surface 11 of the base 10 adjacent to one of the axial directions, with the first pressing mechanism 20 comprising the first lever 21 and the first operating component 22 controlling the displacement of the first lever 21; the second pressing mechanism 30 mounted on the component mounting surface 11 of the base 10 adjacent to one of the axial directions and spaced apart from the first pressing mechanism 20, with the second pressing mechanism 30 comprising the second lever 31 spaced from the first lever 21 of the first pressing mechanism 20, and both the first lever 21 and lever 31 having a stopping component 315 (note: in this embodiment, it is on the second lever 31); a resilient preloading component 40 installed on either the first lever 21 of the first pressing mechanism 20 or the second lever 31 of the second pressing mechanism 30, with the resilient preloading component 40 consisting of a resilient support component 41 between the limiting component 316 of the second lever 31 (or the first lever 21) and the stopping component 315, allowing resilient preloading of the stopping component 315.

As is shown in FIG. 2, in this embodiment, the second lever 31 (or the first lever 21) comprises a fixed inner seat 311 and a movable club head 312 harnessed to the periphery of the fixed inner seat 311, with the stopping component 315 installed on one end of the movable club head 312, and a groove 313 (with a stop flange 314 inside) harnessed to the periphery of the fixed inner seat on the other end of the movable club head 312 away from the stopping component 315; the fixed inner seat 311 has a bearing 317 which is loosely engaged with the movable club head 312 and the groove 313. The limiting component 316 is installed on one side of the bearing 317, allowing the resilient top support 41 of the resilient preloading component 40 to be in the form of a coil spring. The resilient preloading component 40 is installed between the stop flange 314 and the limiting component 316. An anti-trip ring 318 is installed at the inner end of the groove 313.

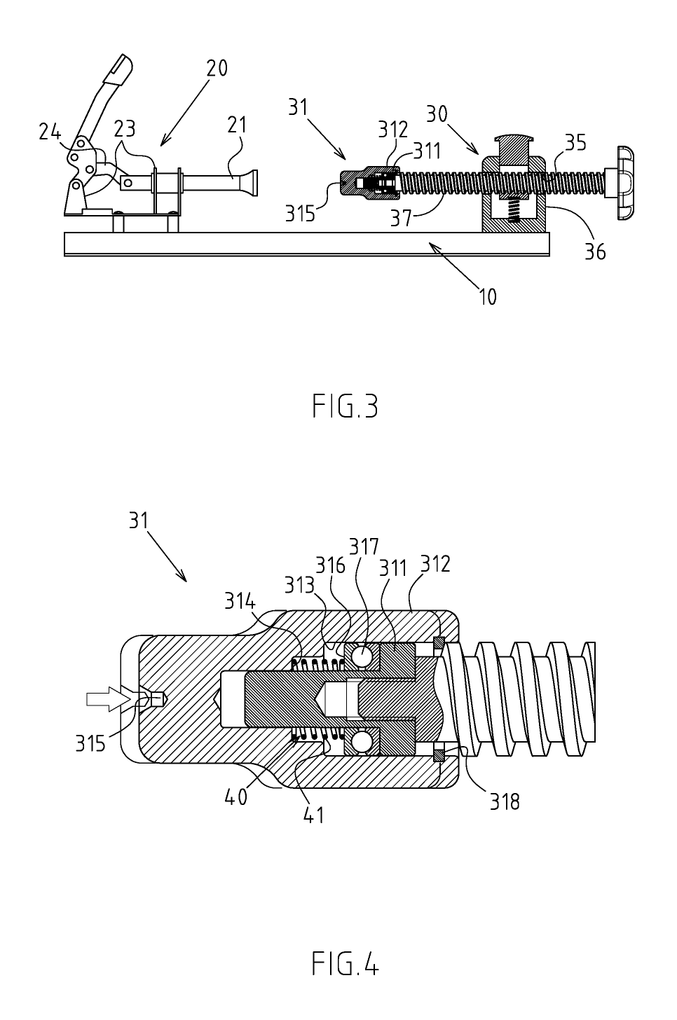

As is shown in FIGS. 1 and 3, in this embodiment, the first pressing mechanism 20 is a lever-type pressing mechanism comprising a holder 23 for the installation of the first pressing mechanism 20 and the first operating component 22 in the form of a lever moving the first lever 21 of the first pressing mechanism 20 via the interlocking member 24; the second pressing mechanism 30 is a screw-adjusting-type pressing mechanism comprising a fixed seat 36 having a transverse through hole 35 and a threaded rod 37 which is inserted into the transverse through hole 35, so that the second lever 31 and the second operating component 32 are installed at both ends of the threaded rod 37, wherein the second operating component 32 is in the form of a knob controlling the threaded rod 37 in a rotational manner.

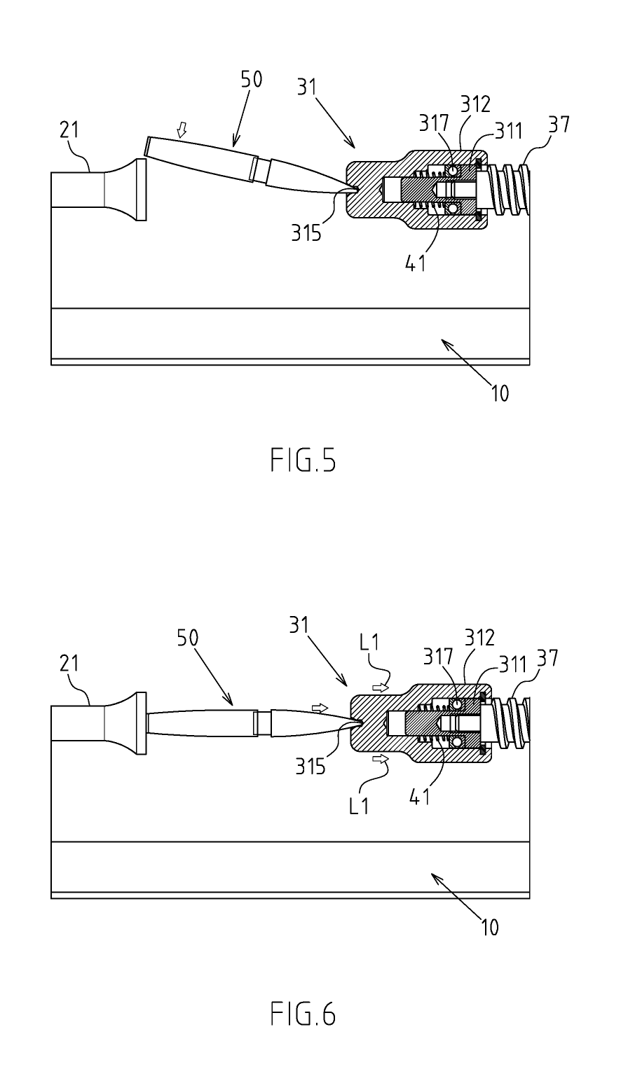

According to said component structure and technical features, the operation of the pen assembly press in the present invention is shown in FIG. 5. When the user fits the pen 50 to be pressed between the lever 21 and the second lever 31, if the pen 50 is only slightly longer than the distance between the lever 21 and the second lever 31, as shown in FIG. 6, only by pushing up the second lever 31 with the resilient support component 41 (as shown by the arrow L1), one can easily clamp the pen 50 between the first lever 21 and the second lever 31. The pen 50 is only inserted and clamped but will not fall easily. Therefore, the user can adjust the pen 50 to the proper horizontal position, and then move the first pressing mechanism 20 to finish the pressing of the pen 50 (that is, press pen body tube and the pen nib tube against each other). The main advantage of the present invention is that the resilient preloading component 40 allows the user to clamp the pen 50 due to the resilient preloading function. It is therefore convenient for the user to move the pen 50 to the proper horizontal position with one hand and operate the first pressing mechanism 20 with the other hand, ensuring more convenient and smooth use and operation of the pen assembly press and more accurate positioning.

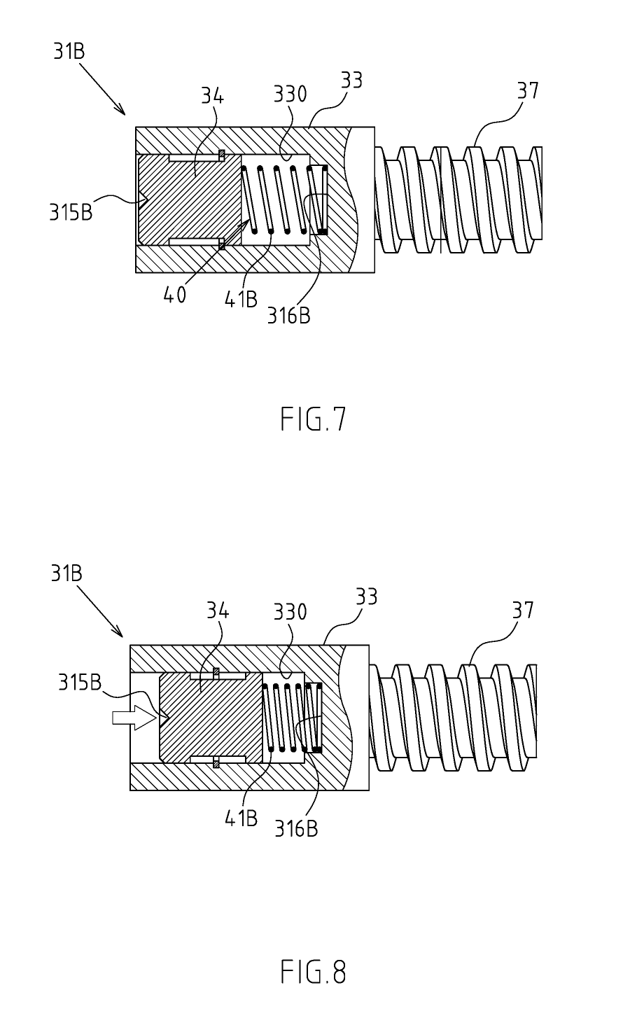

As is shown in FIG. 7, in this embodiment, the second lever 31B (or the first lever 21) comprises a fixed club head 33 having a receiving groove 330 and a movable inner seat 34 in the fixed club head 33. The stopping component 315B is installed at the end of the movable inner seat 34, and the limiting component 316B at the inner wall of the receiving groove 330. The resilient top support 41B of the resilient preloading component 40 is in the form of a coil spring installed between the limiting component 316B and the movable inner seat 34.

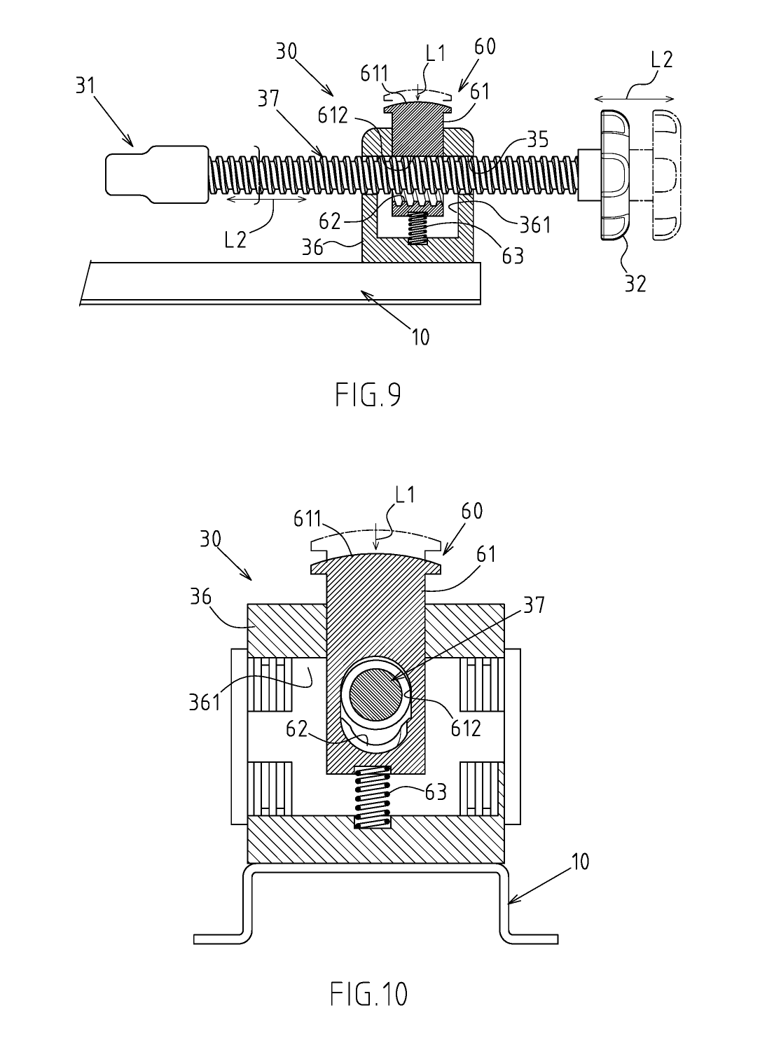

As is shown in FIGS. 9 and 10, at the place where the fixed seat 36 of the second pressing mechanism 30 of screw-adjusting type and the threaded rod 37 join, there is a threaded-rod-type switching component 60 which comprises a columnar block 61 with a handling component 611 at its top for engaging the tooth 62 of the threaded rod 37 and a return spring 63. The fixed seat 36 has a fitting groove 361, on the top of which the columnar block 61 can be installed. The columnar block 61 has a through hole 612 for the threaded rod 37 to be loosely fitted. The through hole 612 is larger than the maximum outer diameter of the threaded rod 37. The tooth 62 is at the bottom of the through hole 612, and the distance from the tooth peak of the tooth 62 to the top wall of the through hole 612 is greater than the maximum outer diameter of the threaded rod 37. The handling component 611 is exposed outside the fixed seat 36. The return spring 63 is installed between the bottom of the columnar block 61 and the bottom wall of the fixed seat 36 to engage columnar block 61 supported by the return coil and the threaded rod 37. When the user presses the columnar block 61 with the handling component 611 (as indicated by the arrow L1), the tooth 62 will be displaced from the threaded rod 37, thereby releasing constituting the threaded rod 37 which can then be pushed and pulled rapidly (as indicated by the arrow L2).

I claim:

1. A type of pen assembly press comprising:
a base in the form of a long seat extending in an axial direction, consisting of a component mounting surface;
the first pressing mechanism mounted on the component mounting surface of the base adjacent to one of the axial directions, with the first pressing mechanism comprising the first lever and the first operating component controlling the displacement of the first lever;
the second pressing mechanism mounted on the component mounting surface of the base adjacent to one of the axial directions and spaced apart from the first pressing mechanism, with the second pressing mechanism comprising the second lever spaced from the first lever of the first pressing mechanism, and both the first lever and lever having a stopping component;
a resilient preloading component installed on either the first lever of the first pressing mechanism or the second lever of the second pressing mechanism, with the resilient preloading component consisting of a resilient support component between the limiting component of the second lever or the first lever and the stopping component, allowing resilient preloading of the stopping component to a certain distance.

2. The device defined in claim 1, wherein the first lever or the second lever includes a fixed inner seat and a movable club head harnessed to the periphery of the fixed inner seat, with the stopping component installed on one end of the movable club head, and a groove (with a stop flange inside) harnessed to the periphery of the fixed inner seat on the other end of the movable club head away from the stopping component; the fixed inner seat has a bearing which is loosely engaged with the movable club head and the groove; the limiting component is installed on one side of the bearing, allowing the resilient top support of the resilient preloading component to be in the form of a coil spring; the resilient preloading component is installed between the stop flange and the limiting component; an anti-trip ring is installed at the inner end of the groove.

3. The device defined in claim 1, wherein the first lever or the second lever comprises a fixed club head having a receiving groove and a movable inner seat in the fixed club head; the stopping component is installed at the end of the movable inner seat, and the limiting component at the inner wall of the receiving groove; the resilient top support of the resilient preloading component is in the form of a coil spring installed between the limiting component and the movable inner seat.

4. The device defined in claim 1, wherein the first pressing mechanism is a lever-type pressing mechanism comprising a holder for the installation of the first pressing mechanism and the first operating component in the form of a lever moving the first lever of the first pressing mechanism via the interlocking member; the second pressing mechanism is a screw-adjusting-type pressing mechanism comprising a fixed seat having a transverse through hole and a threaded rod which is inserted into the transverse through hole, so that the second lever and the second operating component are installed at both ends of the threaded rod, wherein the second operating component is in the form of a knob controlling the threaded rod in a rotational manner.

5. The device defined in claim 4, wherein at the place where the fixed seat of the second pressing mechanism of screw-adjusting type and the threaded rod join, there is a threaded-rod-type switching component which comprises a columnar block with a handling component at its top for engaging the tooth of the threaded rod and a return spring; the fixed seat has a fitting groove, on the top of which the columnar block can be installed; the columnar block has a through hole for the threaded rod to be loosely fitted; the through hole is larger than the maximum outer diameter of the threaded rod; the tooth is at the bottom of the through hole, and the distance from the tooth peak of the tooth to the top wall of the through hole is greater than the maximum outer diameter of the threaded rod; the handling component is exposed outside the fixed seat; the return spring is installed between the bottom of the columnar block and the bottom wall of the fixed seat to engage columnar block supported by the return coil and the threaded rod; when the user presses the columnar block with the handling component, the tooth will be displaced from the threaded rod, thereby releasing constituting the threaded rod which can then be pushed and pulled rapidly.

6. The lever of a pen assembly press is installed on either of the pressing mechanisms of the pen assembly press; the lever has a stopping component and a resilient preloading component which consists of a resilient support component between the limiting component and the stopping component, allowing resilient preloading of the stopping component to a certain distance.

7. The device defined in claim 6, wherein the lever comprises a fixed inner seat and a movable club head harnessed to the periphery of the fixed inner seat, with the stopping component installed on one end of the movable club head, and a groove (with a stop flange inside) harnessed to the periphery of the fixed inner seat on the other end of the movable club head away from the stopping component; the fixed inner seat has a bearing which is loosely engaged with the movable club head and the groove; the limiting component is installed on one side of the bearing, allowing the resilient top support of the resilient preloading component to be in the form of a coil spring; the resilient preloading component is installed between the stop flange and the limiting component; an anti-trip ring is installed at the inner end of the groove.

8. The device defined in claim 6, wherein the lever comprises a fixed club head having a receiving groove and a movable inner seat in the fixed club head; the stopping component is installed at the end of the movable inner seat, and the limiting component at the inner wall of the receiving groove; the resilient top support of the resilient preloading component is in the form of a coil spring installed between the limiting component and the movable inner seat.
